(19) United States
(12) Patent Application Publication
(10) Pub. No.: US 2006/0288035 A1
(43) Pub. Date: Dec. 21, 2006

(54) Relational database support for immutable media

(75) Inventor: Steven Viavant, Piedmont, CA (US)

Correspondence Address: MCDONALD HOPKINS CO., LPA, 600 SUPERIOR AVE., E., SUITE 2100, CLEVELAND, OH, 44114, US

(73) Assignee: ORACLE INTERNATIONAL CORPORATION, REDWOOD SHORES, CA (US)

(21) Appl. No.: 11/154,867

(22) Filed: Jun. 16, 2005

(51) Int. Cl. G06F 7/00

(52) U.S. Cl. 707/102

(57) ABSTRACT

Example systems, methodologies, media, and other embodiments are described herein that relate to database systems. In one example system embodiment, a logic can be configured to monitor transactions that are performed by a computer system and store data relating to the transactions in an data store that is maintained on an immutable storage medium. An indexing logic can be configured that generates one or more indexes for the data store where the one or more indexes are maintained on a mutable medium.

### BACKGROUND

Audit is an area of rapidly growing importance to businesses. Regulatory requirements like the Sarbanes-Oxley Act mandate that strict and reliable audit trails be maintained for large classes of businesses. These regulations are widely interpreted and can include requirements to maintain audit trails for database activity.

Databases and database application software may include a built-in audit system that can create an audit trail for selected database activities. Over time, questions may arise as to the integrity of the audit trail data. For example, if the audit trail data is stored in tables of a database, a sufficiently privileged database administrator can alter the audit trail. In another example, if the audit trail data is streamed to a write-once file (e.g. mounted on a write-once media like a write-once DVD), ad-hoc queries of the audit trail become very difficult to write, and very slow to execute. Challenges occur when trying to balance between making the audit trail secure and providing convenient access to the audit trail. Besides audit data, these challenges also apply to other types of transactions and/or documents that are to be keep immutable over time, which are also regarded herein as audit data.

### BRIEF DESCRIPTION OF THE DRAWINGS

The accompanying drawings, which are incorporated in and constitute a part of the specification, illustrate various example systems, methods, and so on that illustrate various example embodiments of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Of course, embodiments and/or elements can be combined with other embodiments to produce variations of the systems and methods, and their equivalents.

FIG. 1 illustrates an example embodiment where indexes are separate from data.

FIG. 2 illustrates an example embodiment of different tablespaces created for a database.

FIG. 3 illustrates an example diagram of an audit data space and indexes for the audit data.

FIG. 4 illustrates an example methodology that can be associated with generating audit data and indexes on separate storage devices.

FIG. 5 illustrates an example embodiment where data of a database and an index of the database are controlled through different device drivers.

FIG. 6 illustrates an example methodology associated with mounting different device drivers.

FIG. 7 illustrates an example computing environment in which the example systems and methods described herein can operate.

### DETAILED DESCRIPTION

Systems, methodologies, computer-readable media, and other embodiments associated with relational databases are described. In one embodiment, a database can be configured to maintain its data on one type of storage media while indexes to the data are maintained on a different type of media. For example, the data can be maintained on an immutable storage media so that the data is not susceptible to modification. The indexes to the data can be maintained on a mutable media so that the indexes can be easily modifiable to provide convenient access to the immutable data. In this manner, relational database support by way of the relational indexes can be provided for an immutable media.

In one embodiment, the immutable data may be an audit trail that is recorded from computer transactions like database activities. Of course, the audit trail can be other types of data like financial records or other desired data that is to be made reliable over time, secure, and/or immutable. The indexes can allow a user to create and execute convenient ad-hoc queries that would otherwise be difficult perform against a flat file.

It will be appreciated that in the following examples and claims, the terms data, audit data, and audit trail are used for explanatory purposes and are used interchangeably. These terms are intended to represent and include any type of data, including digital documents, financial transactions, data base activities, full text and details of day-to-day business transactions, that are to be stored with assurances of immutability over time. One or more example embodiments herein can simultaneously maintain the flexibility to rebalance indices as the volume of the immutable data grows, skew characteristics of the immutable data change over time, and as index structures and definitions of which fields are to be indexed change over time to add efficiency to changing patterns of query logic.

The following includes definitions of selected terms employed herein. The definitions include various examples and/or forms of components that fall within the scope of a term and that may be used for implementation. The examples are not intended to be limiting. Both singular and plural forms of terms may be within the definitions even when only a singular term is used.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate signals, instructions, data, or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device like a field programmable gate array (FPGA), a memory device containing instructions, combinations of logic devices, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. In the context of a network connection, an operable connection may be created though one or more computing devices and network components. Logical and/or physical communication channels can be used to create an operable connection.

“Signal”, as used herein, includes but is not limited to one or more electrical or optical signals, analog or digital signals, a bit or bit stream, and/or other means that can be received, transmitted and/or detected. A signal can also take other forms such as data, one or more computer or processor instructions, messages, and the like.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a driver, a function call (local and/or remote), a servelet, an applet, instructions stored in a memory, part of an operating system, or other types of executable instructions. It will be appreciated by one of ordinary skill in the art that the form of software may be dependent on, for example, requirements of a desired system, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium can have a form of signals that represent the software/firmware as it is downloaded from a web server to a user. In another example, the computer-readable medium can have a form of the software/firmware as it is maintained on the web server. Other forms may also be used.

“User”, as used herein, includes but is not limited to one or more persons, software, computers or other devices, or combinations of these.

Some portions of the detailed descriptions that follow are presented in terms of methods, algorithms, and/or symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, intercepting, storing, redirecting, detecting, determining, displaying, or the like, refer to actions and processes of a computer system, logic, processor, or similar electronic device that manipulates and/or transforms data represented as physical (electronic) quantities.

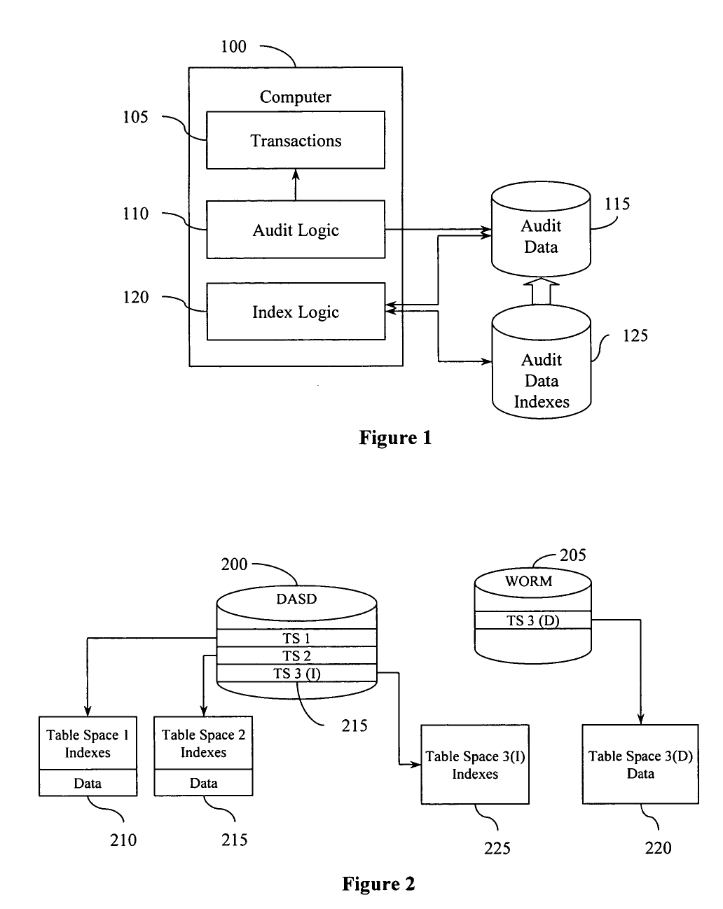

With reference to the figures, FIG. 1 illustrates one example embodiment of a system that separates indexes from data and maintains the indexes and the data on two different media types. In one embodiment, the system can be configured to operate in a computer 100 and will be described with reference to an auditing system. In one example, the auditing system can be configured to monitor and record one or more types of transactions 105 that may be processed by the computer 100. It will be appreciated that computer 100 can also represent multiple computers connected to one or more networks and that the transactions 105 can be monitored on any selected computer within the networks. Example transactions 105 can include activities performed with one or more databases like accessing records, changing passwords, reading files, modifying data, manipulating financial transactions (e.g. stock sales, orders, banking), manipulating business transactions, and/or other type of transaction desired to be monitored.

In one embodiment, the auditing system can include a logic like an audit logic 110 that is configured to monitor one or more of the transactions 105 that are performed by the computer 100. Data collected from the monitored transactions will be referred to as audit data and/or an audit trail as previously defined. In general, audit data refers to any data that is to be stored on an immutable media. As will be described, the system is configured to store the immutable data in a relational (e.g. object-relational and the like) data base while supporting flexible, dynamic indices on the immutable data for rapid, ad-hoc access. Software systems, like a data base management system, typically include mechanisms for audit tracking. The present system is not directed to particular mechanisms for tracking activities so these mechanisms will not be described in great detail. They are, however, involved to provide audit data and will be described in that context.

The audit logic 110 can also be configured to store the audit data relating to the transactions 105. For example once audit data is collected, the audit data can be stored in an audit data store 115 that is maintained on an immutable storage medium. Examples of an immutable storage medium can include a write-once read many (WORM) media like a write-once DVD or CD. Maintaining the audit data on an immutable storage device provides improved assurances that the data is not capable or susceptible to modification and provides improved guarantees that the audit data will be reliable and secure over time.

The audit system can also include an index logic 120 that can be configured to generate one or more indexes 125 for the audit data 115. In one example, a user interface can be provided that allows an index to be programmatically defined and then generated based on the definitions and applicable fields from the audit data 115. Once generated, the one or more indexes 125 are maintained on a mutable media. In this manner, an audit database can be created that separates its indexes 125 from the data 115 and where the data 115 is prohibited from being modified yet the indexes 125 are modifiable.

With this configuration, the audit data 115 on the write-once media can be supported by relational database features, namely, relational database indexes 125. The indexes 125 can provide the benefits of a relational database like simple to write ad-hoc queries and quick response times for searches against the otherwise difficult to manage immutable audit data 115. In other example, the audit logic 110 can include a query logic configured to retrieve data from the audit data store 115 by using relational data base queries and the one or more indexes 125 from the mutable media.

In another embodiment, the audit data store 115 and the indexes 125 can be configured in different database tablespaces. One example embodiment will be described with reference to FIG. 2. FIG. 2 illustrates a logical representation of two storage mediums that can include a mutable medium like direct access storage device (DASD) 200 and an immutable storage medium like a write-once read many (WORM) medium 205. The DASD 200 is illustrated with three example database tablespaces identified as tablespace TS1, tablespace TS2, and tablespace TS3(I).

In general, a tablespace designates a logical structure that administrators use to manage placement and growth of data in a database. Tablespaces, in turn, contain other logical structures such as tables, indexes, and any other type of object that consumes space for data. In a database management system (DBMS), a tablespace can be a logical group of data files in a database. A typical database can contain at least one tablespace, and usually two or more. A tablespace can play a role similar to that of a folder on the hard drive of a computer. Some database programs, such as Oracle, automatically create a tablespace called SYSTEM that contains general information about the structure and contents of the database. A small database can be entirely contained in the SYSTEM tablespace, but in most cases, user data is placed in other tablespaces.

The files in a tablespace usually share a common characteristic. For example, a database for a wholesale distributor might include tablespaces entitled “ACCOUNTING”, “AUDIT”, “ORDERS”, “SHIPPING”, “SERVICE”, and “SYSTEM”. Each tablespace might contain only one data file, or thousands of files, or anything in between. Tablespaces can be created, deleted, and merged.

With continued reference to FIG. 2, tablespace TS1 and TS2 are shown to illustrate a typical database tablespace where the indexes and the data of the database are maintained through the same tablespace. The data and indexes of tablespace TS1 are represented by Block 210. The data and indexes for tablespace 2 are represented by Block 215. Using multiple tablespaces like TS1 and TS2 in this example may be the result of partitioning a data base between multiple users so that actions occurring in one partition does not affect the other partition.

Tablespace 3 illustrates an example configuration that can be used with the audit data shown in FIG. 1. For example, tablespace 3 includes two separate and different tablespaces that are represented as TS3(I) and TS3(D). Tablespace TS3(I) is associated with the indexes for tablespace 3 and tablespace TS3(D) is associated with the actual data. The indexes 225 maintain selected maps and/or associations to various groups of data within the data in tablespace 3(D) 220.

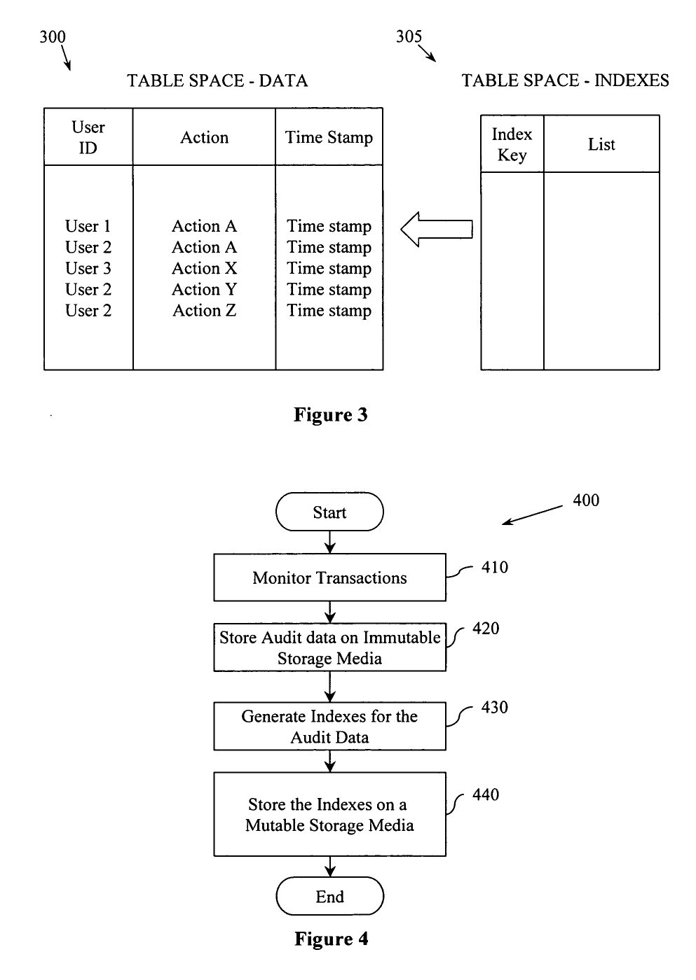

Illustrated in FIG. 3 is one logical example of a tablespace 300 configured to maintain data and a tablespace 305 configured to maintain indexes for the tablespace 300. Suppose that selected transactions are being audited and are being stored on a per user basis. The tablespace 300, which maintains the audit data, can be configured to store, for example, a user identifier (ID), actions taken by the user, and a time stamp of when the action was performed. Of course, different types of fields can be used. The tablespace 300 can include an audit trail for one or more users that may be interacting with one or more databases, one or more computer systems, or one or more computer networks. As previously explained, the tablespace 300 containing the audit data is maintained on an immutable medium whereas the tablespace 305 containing the indexes is contained on a separate, mutable storage medium. This allows the indexes 305 to be easily updatable and modifiable so that queries against the immutable data on tablespace 300 may be accessed with the benefits of a relational database index.

Example methods may be better appreciated with reference to flow diagrams. While for purposes of simplicity of explanation, the illustrated methodologies are shown and described as a series of blocks. However, it is to be appreciated that the methodologies are not limited by the order of the blocks, as some blocks can occur in different orders, occur at different times, and/or occur concurrently with other blocks from that shown and described. Moreover, less than all the illustrated blocks may be required to implement an example methodology. Furthermore, additional and/or alternative methodologies can employ additional, not illustrated blocks.

In the flow diagrams, blocks denote “processing blocks” that may be implemented with logic. In the case where the logic may be software, a flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that electronic and software logic may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques. The processes are not limited to a specific programming approach.

It will be appreciated that a methodology can be embodied by a computer-readable medium that provides processor-executable instructions operable with a computing device. The processor executable instructions can be configured to be operable to perform each respective methodology and it's equivalents.

Illustrated in FIG. 4 is one embodiment of a methodology that can be associated with creating an audit trail. The methodology 400 can begin with monitoring selected transactions that may occur in one or more computer systems (Block 410). Data that is collected from the transactions will be referred to as audit data although it will be appreciated that different types of data can be monitored and stored. The audit data can then be stored on an immutable storage media (Block 420). Once the data is created, indexes can be periodically generated at different points in time for the audit data (Block 430). The indexes are then stored on/in a mutable storage media (Block 440). As previously described, storing the indexes on/in a mutable media allows the indexes to be easily modifiable in order to provide improved searching capabilities against the immutable data.

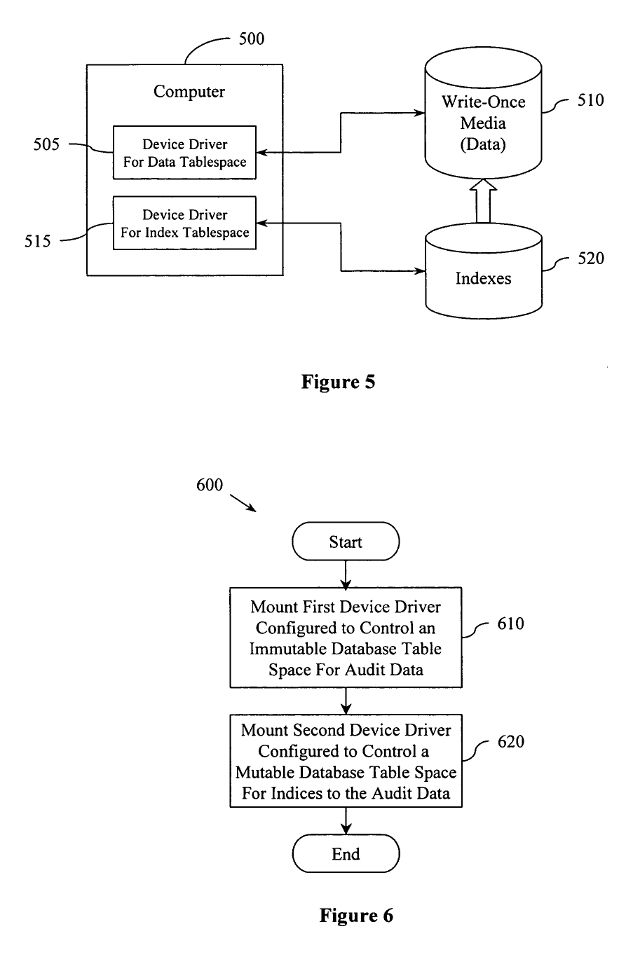

Illustrated in FIG. 5 is one example embodiment of a computer 500 configured to operate different device drivers for the immutable data and mutable indexes. The computer 500 can include a first device driver 505 that is configured to control access to a tablespace for immutable data stored on a write-once media 510. The computer 500 can also include a second device driver 515 configured to provide access and control to indexes 520 maintained on a mutable media that is separate from the write-once media 510. In this manner, separate database tablespaces can be configured for a single logical database.

It will be appreciated that the tablespaces can be configured in alternate ways like having a single tablespace defined that includes two sub-spaces where one is for the write-once media 510 and the other sub-space is for the mutable media 520 such as a DASD. In one example implementation, a database application can include a database kernel configured to mount different tablespaces for the data and the indexes. Additional features can be implemented such as providing validation of the index space and/or data. For example, if a “write” and then an “update” operation is requested to be performed against the write-once data 510, an error message can be provided that explains that the update operation is prohibited.

Illustrated in FIG. 6 is an example methodology that can be associated with the system of FIG. 5. The methodology can include mounting a first device driver that is configured to control an immutable database tablespace for audit data (Block 610). A second device driver can also be mounted that is configured to control a mutable database tablespace (Block 620). The mutable tablespace is configured to maintain the indexes that provide relational support for the audit data on the immutable database table.

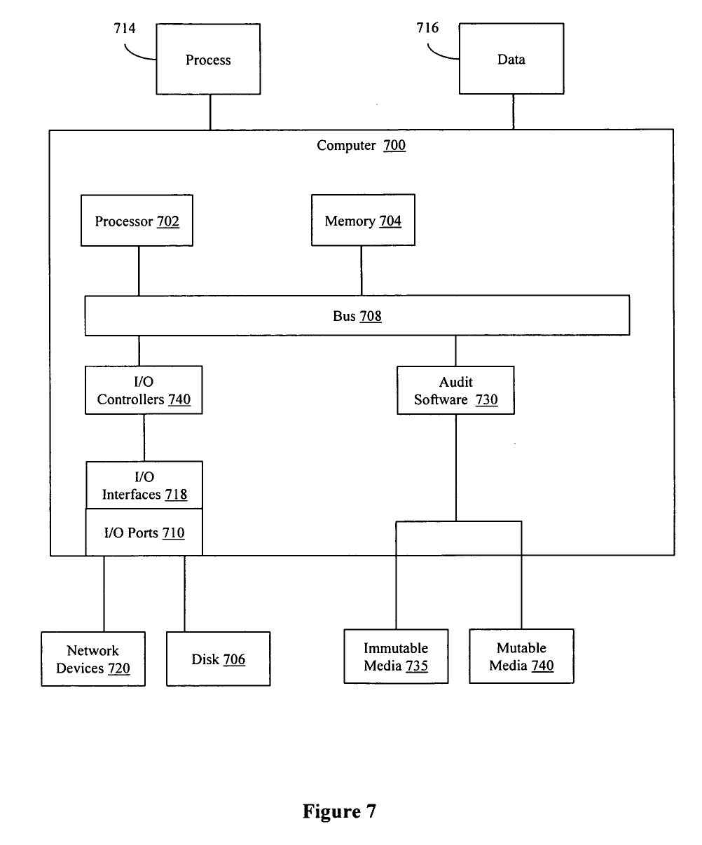

FIG. 7 illustrates an example computing device in which example systems and methods described herein, and equivalents, can operate. The example computing device may be a computer 700 that includes a processor 702, a memory 704, and input/output ports 710 operably connected by a bus 708. In one example, the computer 700 can be configured with audit software 730 that collects, stores, and/or retrieves audit data like audit logic 110 as previously described with reference to FIG. 1. The audit software 730 can be configured to store audit data on an immutable media 730 and provide indexes to the immutable audit data on a mutable media 740 as previously described. It will be appreciated that the mutable media 740 can also be configured as an internal memory/storage within the computer 700, or can be a combination of internal and external memory/storage. The immutable media 735 and the mutable media 740, along with the audit software 730, can be implemented similar to the previously described embodiments, or their equivalents.

Generally describing an example configuration of the computer 700, the processor 702 can be a variety of various processors including dual microprocessor and other multi-processor architectures. The memory 704 can include volatile memory and/or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 706 may be operably connected to the computer 700 via, for example, an input/output interface (e.g., card, device) 718 and an input/output port 710. The disk 706 can include, but is not limited to, devices like a magnetic disk drive, a solid state disk drive, a floppy disk drive, a tape drive, a Zip drive, a flash memory card, and/or a memory stick. Furthermore, the disk 706 can include optical drives like a CD-ROM, a CD recordable drive (CD-R drive), a CD rewriteable drive (CD-RW drive), and/or a digital video ROM drive (DVD ROM). The memory 704 can store processes 714 and/or data 716, for example. The disk 706 and/or memory 704 can store an operating system that controls and allocates resources of the computer 700.

The bus 708 can be a single internal bus interconnect architecture and/or other bus or mesh architectures. While a single bus is illustrated, it is to be appreciated that computer 700 may communicate with various devices, logics, and peripherals using other busses that are not illustrated (e.g., PCIE, SATA, Infiniband, 1394, USB, Ethernet). The bus 708 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 700 may interact with input/output devices via i/o interfaces 718 and input/output ports 710. Input/output devices can include, but are not limited to, a keyboard, a microphone, a pointing and selection device, cameras, video cards, displays, disk 706, network devices 720, and the like. The input/output ports 710 can include but are not limited to, serial ports, parallel ports, and USB ports.

The computer 700 can operate in a network environment and thus may be connected to network devices 720 via the i/o devices 718, and/or the i/o ports 710. Through the network devices 720, the computer 700 may interact with a network. Through the network, the computer 700 may be logically connected to remote computers. The networks with which the computer 700 may interact include, but are not limited to, a local area network (LAN), a wide area network (WAN), and other networks. The network devices 720 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, the network devices 720 can connect to WAN technologies including, but not limited to, point to point links, circuit switching networks like integrated services digital networks (ISDN), packet switching networks, and digital subscriber lines (DSL).

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A system, comprising:
a logic configured to monitor transactions that are performed by a computer system and store data relating to the transactions in a data store that is maintained on an immutable storage medium; and
indexing logic configured to generate one or more indexes for the data store where the one or more indexes are maintained on a mutable medium.

2. The system of claim 1, where the data store and the one or more indexes are configured in different data base tablespaces.

3. The system of claim 1 where the data store is maintained in a write-once read-many storage media.

4. The system of claim 1 where the mutable medium allows the one or more indexes to be modifiable and allows for ad-hoc search queries to be performed against the data store.

5. The system of claim 1 further including a query logic configured to retrieve data from the data store by using relational data base queries and the one or more indexes configured on the mutable medium.

6. The system of claim 1 where the system is embodied as software, or as a computer-readable medium configured with processor executable instructions.

7. The system of claim 1 where the data store and the one or more indexes are configured as part of a relational database.

8. A data processing system, comprising:
one or more computers configured to process transactions;
an audit software configured to monitor selected transactions processed by the one or more computers;
an audit data store configured to store audit data relating to the selected transactions on a write-once medium to prevent modification of the audit data; and
an audit index for accessing the audit data store where the index is configured on a modifiable medium to allow ad-hoc queries to the audit data store.

9. The data processing system of claim 8 where the audit data store and the index are configured in a different database tablespaces.

10. The data processing system of claim 8 further including a plurality of audit data stores configured to store audit data relating to selected transactions from selected computers of the one or more computers.

11. The data processing system of claim 8 where the audit data store is configured as a centralized data store to contain audit data from multiple databases.

12. The data process system of claim 8 where the audit data store and the audit index are configured in database tablespaces that are separate from each other.

13. The data processing system of claim 8 further including:
a first device driver configured to control access to the audit data store on the write-once medium; and
a second device driver configured to control access to the audit index on the modifiable medium.

14. The data processing system of claim 8 where the write-once medium includes a write-once read many medium.

15. The data processing system of claim 8 where the selected transactions that are monitored by the audit tracking software are database transactions.

16. A computer-readable medium that provides processor executable instructions operable to perform a method of configuring a computer system, the method comprising:
mounting a first device driver configured to control access to a write-once database tablespace configured to store data; and
mounting a second device driver configured to control access to a mutable database tablespace configured to maintain indexes to the write-once database tablespace to facilitate query operations on the data.

17. The computer-readable medium of claim 16 further including processor executable instructions for:
storing audit data to the write-once database tablespace via the first device driver; and
querying the audit data by using the indexes via the second device driver.

18. A computer-readable medium storing processor executable instructions operable to perform a method, the method comprising:
monitoring transactions performed on one or more computer systems;
storing audit data relating to the transactions on an immutable storage device;
generating one or more indexes configured to provide access to the audit data; and
storing the one or more indexes on a mutable storage device.

19. A system, comprising:
means for collecting data from database activities;
means for maintaining the data on an immutable media that is not susceptible to modification; and
means for maintaining relational database indexes on a mutable media that facilitates queries to be performed on the data on the immutable media.
